(19) United States
(12) Patent Application Publication
(10) Pub. No.: US 2020/0034949 A1
(43) Pub. Date: Jan. 30, 2020

(54) GENERATING RADIOMETRICALLY CORRECTED SURFACE IMAGES

(71) Applicant: STELLENBOSCH UNIVERSITY, Stellenbosch (ZA)

(72) Inventors: Adriaan van Niekerk, Stellenbosch (ZA); Dugal Jeremy Harris, Cape Town (ZA)

(21) Appl. No.: 16/335,702

(22) PCT Filed: Sep. 21, 2017
(86) PCT No.: PCT/IB2017/055729

§ 371 Date: Mar. 22, 2019

(30) Foreign Application Priority Data
Sep. 23, 2016 (ZA) 2016/06581

(51) Int. Cl. G06T 3/40; G06T 7/73

(52) U.S. Cl. CPC G06T 3/4061; G06T 7/75; G06T 2207/30188; G06T 2207/10036; G06T 3/4038

(57) ABSTRACT

A system and method for generating radiometrically corrected surface images is provided. This includes providing one or more surface images of a first resolution of a surface area in the form of digital images which has a surface image sensor measurement of an intensity value of radiation in a given wavelength band reflected from the surface for each pixel of the images. A reference image of a second resolution of a corresponding surface area is provided to the surface of the surface image. The reference image has a surface reflectance for each pixel of the reference image for an equivalent wavelength band to the given wavelength band of the surface image. A functional relationship is modelled which relates the surface image sensor measurement for pixels of a surface image to the surface reflectance for pixels of the reference image to provide an estimated surface reflectance for each pixel of the surface images.

### CROSS-REFERENCE(S) TO RELATED APPLICATIONS

This application claims priority from South African provisional patent application number 2016/06581 filed on 23 Sep. 2016, which is incorporated by reference herein.

### FIELD OF THE INVENTION

This invention relates to generating radiometrically corrected surface images. In particular, it relates to correction of surface images with reference to a reference image.

### BACKGROUND TO THE INVENTION

Very high resolution (VHR) aerial and drone imagery is increasingly being used in remote sensing studies. The high spatial resolution of these images enables analysis on a finer spatial scale than most satellite based platforms can provide and consequently allows the exploitation of information such as texture, object-based features and unmixed pixel spectra that is not available in lower resolution images (Chandelier and Martinoty, 2009; Collings et al., 2011; Honkavaara et al., 2009; López et al., 2011; Markelin et al., 2012).

Accurate geometric calibration techniques for producing orthorectified images are well established and form part of typical aerial imagery processing workflows (Chandelier and Martinoty, 2009). Because aerial image mosaics are commonly produced for the purpose of visual interpretation, techniques such as dodging and look up tables (LUTs) are often used to produce smooth and visually appealing results (López et al., 2011). This kind of adjustment can damage the spectral information content and is not suited to quantitative remote sensing.

Ideally quantitative analyses should be carried out on reflectance values, but extraction of surface reflectance from aerial imagery remains a challenge. Also, spatial and temporal radiometric variations in aerial imagery limit the extent over which quantitative remote sensing techniques can be successfully applied (Markelin et al., 2012). Atmospheric influences, bidirectional reflectance distribution function (BRDF) effects and sensor variations all contribute to radiometric variations in the imagery. To obtain surface reflectance, these radiometric variations must be reduced as far as possible.

There is some confusion and ambiguity around the use of reflectance terminology in the literature (Schaepman-Strub et al., 2006). In this description, “surface reflectance” is used to mean the bi-directional surface reflectance at local solar noon and viewed at nadir. It is worth noting that as it is not possible or practical to correct for all the sources of radiometric variation in aerial imagery and that surface reflectance in most so-called “corrected” or “calibrated” images is only an approximation to the actual value.

A number of techniques for the correction of BRDF effects are available, including the popular kernel-based method (Roujean et al., 1992). Approaches based on radiometric transfer modelling (RTM), such as ATCOR (Richter, 1997), MODTRAN (Berk et al., 1999) and 6S (Vermote et al., 1997) are used for atmospheric correction. While these atmospheric and BRDF correction methods are effective on single images (Markelin et al., 2012), blocks of multiple aerial images present new challenges. The large view angles of aerial imaging cameras cause the solar and viewing geometries to vary significantly through the image (Lelong et al., 2008). Aerial campaigns are usually carried out over multiple days resulting in significant variation in BRDF and atmospheric conditions. Each land cover also has its own unique BRDF conditions and corrections should ideally model each of these covers separately (Collings et al., 2011; Honkavaara et al., 2009). Techniques that account for land cover specific BRDF's require an upfront cover classification which is time-consuming and introduces another potential source of error. Aerial campaigns can also consist of thousands of images making it impractical to apply time consuming atmospheric and BRDF correction models to every image (López et al., 2011). Even if it was practical, remnant radiometric variation due to the inexact nature of BRDF and atmospheric corrections will result in discontinuities, or seam lines, between adjacent images.

Approaches to calibrating mosaics of aerial imagery are receiving increasing attention (Chandelier and Martinoty, 2009; Collings et al., 2011; Gehrke, 2010; Lopez et al., 2011). All of these approaches exploit the fact that adjacent images contain significant portions of overlap and that in a perfectly calibrated mosaic, these overlapping portions of different images should be identical. Collings et al. (2011) introduced a spatially varying linear model to perform combined atmospheric and BRDF correction. The parameters of the model are solved by minimising a cost function that considers the internal accuracy of each image, similarity of overlapping image regions and smoothness (i.e. the lack of seam lines) of the mosaic. In a second stage the entire mosaic is calibrated to absolute reflectance using specially placed ground targets with known reflectance. In Chandelier & Martinoty (2009) a simple three parameter model of the combined atmospheric and BRDF effects is fitted by minimising the difference between “radiometric tie-points”, which are a selection of points in the overlapping image regions. It is a relative calibration method and no adjustment to absolute reflectance is made. A similar approach is used in López et al. (2011). Gehrke (2010) uses standard atmospheric and BRDF methods followed by a relative radiometric normalisation (RRN) step using invariant points in overlapping regions to smooth the mosaic.

A disadvantage of the aerial mosaic calibration techniques described above is their complexity and need for known ground references to achieve transformation to absolute surface reflectance. Transformation to an absolute physical quantity such as reflectance is beneficial as this is an invariant property of the surface which allows the data to be used in physical models, fused with other reflectance data and used in multi-temporal studies (Downey et al., 2010; Vicente-Serrano et al., 2008). The options of placing targets of known reflectance to be captured as part of the mosaic or measuring the reflectance of suitably invariant sites on the ground are often not possible or practical. Many applications make use of archived imagery that had been captured prior to the commencement of the research and for which concurrent ground measurements are consequently not possible. Another approach is to make use of vicarious calibration involving knowledge of the spectral characteristics of specific ground sites, but this is recognised as being labour-intensive and costly (Chander et al., 2004; Gao et al., 2013; Liu et al., 2004).

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to an aspect of the present invention there is provided a method for generating radiometrically corrected surface images comprising:
providing one or more surface images of a first resolution of a surface area in the form of one or more digital images having a surface image sensor measurement (DN) of an intensity value of radiation in a given wavelength band reflected from the surface for each pixel of the images;
providing a reference image of a second resolution of a corresponding surface area to the surface area of the one or more surface images, wherein the reference image has surface reflectance (ρt) for each pixel of the reference image for an equivalent wavelength band to the given wavelength band of the one or more surface images; and
modelling a functional relationship that relates the surface image sensor measurement for pixels of a surface image to the surface reflectance (ρₜ) for pixels of the reference image to provide an estimated surface reflectance for each pixel of the surface images.

Modelling the functional relationship may use a spatially varying local linear model to approximate a relationship between the surface reflectance of the reference image and the surface image sensor measurements of the one or more surface images. The modelling may use a linear relationship in which a surface image sensor measurement (DN) is equal to a first parameter (M) multiplied by surface reflectance (ρₜ) for each pixel of the reference image. The modelling may use a linear relationship with a second parameter (C) to take the form DN=Mρₜ+C. The parameters may be spatially varying parameters estimated from the pixel values of the surface and reference images. In other embodiments, a non-linear model may be used.

The method may include:
resampling the one or more surface images to the second resolution;
estimating the at least one parameter (M,C) of the local linear relationship that relates the surface image sensor measurement for pixels of a surface image to the surface reflectance for pixels of the reference image;
resampling the estimated parameters to the first resolution; and
estimating the surface reflectance for each pixel of the given wavelength band of the one or more surface images using the resampled parameters.

Estimating the at least one parameter (M, C) may use a least squares estimate for each pixel of the reference image inside a sliding window. The step of estimating may estimate two parameters (M,C) in which case the sliding window may use at least two pixels using the equation

$$[ \begin{matrix}M \\ C\end{matrix} ] = {[ \begin{matrix}{ρ}_{t} & 1\end{matrix} ]}^{- 1} DN ,$$

where ρₜ and DN are row vectors of the ρₜ and DN values inside the sliding window, respectively.

The first resolution may be higher than the second resolution in which case the modelling downsamples the one or more surface images and upsamples the at least one parameter.

The method may include treating bounding pixels by discarding only partially included pixels.

The method may be carried out for each wavelength band in multi-spectral surface image. Alternatively, there may be a single band in the surface image.

In one embodiment, the one or more surface images of a first resolution are high resolution, aerial images and the reference image is a low resolution, satellite image, wherein the one or more surface images and the satellite images are obtained at approximately the same time.

The method estimates surface reflectance of the one or more surface images by calibrating the one or more surface images to the reflectance of the reference image. The reference image may be corrected for atmospheric and bidirectional reflectance distribution function effects. The reference image may be used to transform digital numbers of the one or more surface images to surface reflectance values by using the calibrated reference image as a surface reflectance reference to which the one or more surface images are calibrated.

According to another aspect of the present invention there is provided a system for generating radiometrically corrected surface images, comprising:
a surface image receiving component for receiving one or more surface images of a first resolution of a surface area in the form of digital images having a surface image sensor measurement (DN) of an intensity value of radiation in a given wavelength band reflected from the surface for each pixel of the images;
a reference image receiving component for providing a reference image of a second resolution of a corresponding surface area to the surface area of the one or more surface images, wherein the reference image has surface reflectance (ρₜ) for each pixel of the reference image for an equivalent wavelength band to the given wavelength band of the one or more surface images; and
a modelling component for modelling a functional relationship that relates the surface image sensor measurement for pixels of a surface image to the surface reflectance (ρₜ) for pixels of the reference image to provide an estimated surface reflectance for each pixel of the one or more surface images.

The modelling component may use a spatially varying local linear model to approximate a relationship between the surface reflectance of the reference image and the surface image sensor measurements of the surface images. The modelling component may use a linear relationship in which a surface image sensor measurement (DN) is equal to a first parameter (M) multiplied by surface reflectance (ρₜ) for each pixel of the reference image. The modelling may use a linear relationship with a second parameter (C) to take the form DN=Mρₜ+C. The parameters may be spatially varying parameters estimated from the pixel values of the surface and reference images. In other embodiments, a non-linear model may be used.

The system may include:
a first resampling component for resampling the one or more surface images to the second resolution;
a parameter estimating component for estimating the at least one parameter (M, C)) of the local linear relationship that relates the surface image sensor measurement for pixels of a surface image to the surface reflectance for pixels of the reference image;
a second resampling component for resampling the estimated parameters to the first resolution; and
a surface reflectance estimating component for estimating the surface reflectance for each pixel of the given wavelength band of the surface images using the resampled parameters.

The parameter estimating component may estimate the at least one parameter (M, C) using a least squares estimate for each pixel of the reference image inside a sliding window. The parameter estimating component may estimate two parameters (M,C) in which case the sliding window may use at least two pixels using the equation

$$[ \begin{matrix}M \\ C\end{matrix} ] = {[ \begin{matrix}{ρ}_{t} & 1\end{matrix} ]}^{- 1} DN ,$$

where ρₜ and DN are row vectors of the ρₜ and DN values inside the sliding window, respectively.

The first resolution may be higher than the second resolution in which case the first resampling component downsamples the one or more surface images and the second resampling component upsamples the estimated parameters.

The modelling component may include a boundary pixel component for treating bounding pixels of the one or more surface images by discarding only partially included pixels.

In one embodiment, the one or more surface images of a first resolution are high resolution aerial images and the reference image is a low resolution satellite image, wherein the one or more surface images and the satellite images are obtained at approximately the same time.

According to a further aspect of the present invention there is provided a computer program product, the computer program product comprising a computer-readable medium having stored computer-readable program code for performing the steps of:
providing one or more surface images of a first resolution of a surface area in the form of digital images having a surface image sensor measurement (DN) of an intensity value of radiation in a given wavelength band reflected from the surface for each pixel of the images;
providing a reference image of a second resolution of a corresponding surface area to the surface area of the one or more surface images, wherein the reference image has surface reflectance (ρₜ) for each pixel of the reference image for an equivalent wavelength band to the given wavelength band of the one or more surface images; and
modelling a functional relationship that relates the surface image sensor measurement for pixels of a surface image to the surface reflectance (ρₜ) for pixels of the reference image to provide an estimated surface reflectance for each pixel of the surface images.

Further features provide for the computer-readable medium to be a non-transitory computer-readable medium and for the computer-readable program code to be executable by a processor.

Embodiments of the invention will now be described, by way of example only, with reference to the accompanying drawings.

### BRIEF DESCRIPTION OF THE DRAWINGS

In the drawings:

FIG. 1 is a schematic diagram illustrating a system in accordance with the present invention;

FIG. 2 is a flow diagram of an example embodiment of a method in accordance with the present invention;

FIG. 3 is an image of an orientation map used to illustrate the present invention;

FIG. 4 is an aerial image used to illustrate the present invention;

FIG. 5 is a graph showing the relative spectral responses of two cameras used in an example embodiment of the present invention;

FIG. 6 shows graphs of band averaged relationship of two cameras for typical surface reflectances;

FIGS. 7A and 7B show mosaicked surface images on a reference image background, without and with the application of a correction method in accordance with the present invention;

FIGS. 8A and 8B show mosaicked surface images on a reference image background, without and with the application of a correction method in accordance with the present invention;

FIGS. 9A and 9B show graphs of surface reflectance correlation between two cameras, without and with the application of a correction method in accordance with the present invention;

FIGS. 10A, 10B and 10C show false colour renderings to illustrate the results of the application of a correction method in accordance with the present invention;

FIG. 11 is a graph showing the relative spectral responses of a camera used in an example embodiment of the present invention and a camera used for a comparison image;

FIGS. 12A and 12B show graphs of surface reflectance correlation between the two cameras of FIG. 11, without and with the application of a correction method in accordance with the present invention;

FIG. 13 is block diagram showing an example embodiment of a system in accordance with the present invention; and

FIG. 14 illustrates an example of a computing device in which various aspects of the disclosure may be implemented.

### DETAILED DESCRIPTION WITH REFERENCE TO THE DRAWINGS

Images may be taken of the Earth's surface in the form of digital source images referred to as surface images. The surface images may include images of the surface of the Earth including ocean or vegetation surfaces, or the surface of other bodies. Such surface images may be obtained by aerial imagery, including drone imagery, or satellite imagery and may be high resolution. Mosaicking multiple surface images to cover an area results in radiometric variation over temporal and spatial extents. While very high resolution (VHR) aerial imagery holds great potential for quantitative remote sensing, its use has been limited by the unwanted radiometric variation over temporal and spatial extents. The described method and system generate radiometrically corrected surface images by using a reference image. The described method is described with multiple surface images being calibrated by a reference image; however, the method may be used to correct one surface image with the reference image wherein the reference image extent includes the uncalibrated surface image.

The surface images may be digital images each comprising a two dimensional array of individual picture elements called pixels arranged in columns and rows. Each pixel represents an area on the Earth's surface. A pixel has an intensity value and a location address in the two dimensional image. The intensity value represents the measured physical quantity such as the solar radiance in a given wavelength band reflected from the ground, emitted infrared radiation or backscattered radar intensity. This value is normally the average value for the whole ground area covered by the pixel. The intensity of a pixel is digitized and recorded as a digital number. Due to the finite storage capacity, a digital number is stored with a finite number of bits (binary digits). The number of bits determine the radiometric resolution of the image. The address of a pixel is denoted by its row and column coordinates in the two-dimensional image. There is a one-to-one correspondence between the column-row address of a pixel and the geographical coordinates (e.g. longitude, latitude) of the imaged location.

The surface images may be multispectral images consisting of a few image layers, each layer represents an image acquired at a particular wavelength band.

A reference image may be obtained which has been corrected for atmospheric and bidirectional reflectance distribution function (BRDF) effects. For example, this may be a satellite image which may have cover a greater area than the surface images and may be of a lower resolution than the surface images. Although the reference image may be described in the example embodiments as a satellite image, any form of well-calibrated image may be used. In the described method and system, the reference image is used for transforming digital numbers of the surface images to surface reflectance values. The reference image may be a collocated and concurrent, well calibrated reference image (such as a satellite image) used as a surface reflectance reference to which the surface images are calibrated.

A reference image sensor for obtaining the reference image is spectrally similar to a surface image sensor for obtaining the surface images and the two forms of imagery should be acquired at similar times within an acceptable time window. The described method shows that a spatially varying local linear model can be used to approximate the relationship between the surface reflectance of the reference image and digital numbers of the surface images. The model parameters are estimated for each reference image pixel location, using least squares inside a small sliding window.

The technique implicitly corrects for atmospheric and coarse-scale BRDF effects and does not require spectral measurements of field sites or placement of known reflectance targets and produces seamless mosaics of the surface images. Due to its relative simplicity and computational efficiency, it is an attractive alternative to existing calibration methods.

The limits on the reference image and the one or more surface images are dependent on the reference image being well-calibrated, the reference image and uncalibrated surface images having similar bands, and the reference image and uncalibrated surface images being collocated and more or less concurrent. Therefore, the limits are not dependent on the type of sensors or method of obtaining the images and references to satellite and aerial images in the description of the embodiments are for example purposes only.

The method and system may make use of a wide swath width (i.e. wide extent) reference image to correct radiometric inconsistencies in narrow swath width surface images. It is envisaged that the method may be used to correct a one-to-one surface image to a reference image, and the swath width of the images may, in such circumstances, be considered irrelevant.

The method fits a model that relates the digital numbers of pixels within a surface image to those of a reference image acquired at approximately the same time as the surface image. The reference image has similar spectral bands to the surface image. The model is fitted inside a small region (a sliding window) for each pixel location in the reference image so that the local, spatially varying inconsistencies of the surface images can be corrected. Once fitted, the model is inverted and applied to the surface image to more closely match those of the reference image. The method is applied to each band in a multi-spectral image.

The method removes radiometric inconsistencies from surface images. If the reference image has been radiometrically corrected (i.e. represents surface reflectance values), the resulting aerial images will represent modelled surface reflectance values. This means that the surface images can be used for quantitative analysis (for example, image classification). Furthermore, existing very high resolution satellite imager (for example, WorldView-3) may also benefit from the described radiometric correction.

In one embodiment, the method estimates surface reflectance from surface imagery by calibrating to a course-resolution, concurrent and collocated reference image that has already been corrected for atmospheric and BRDF effects. The model parameters are estimated, for each satellite pixel location, using least squares inside a small sliding window.

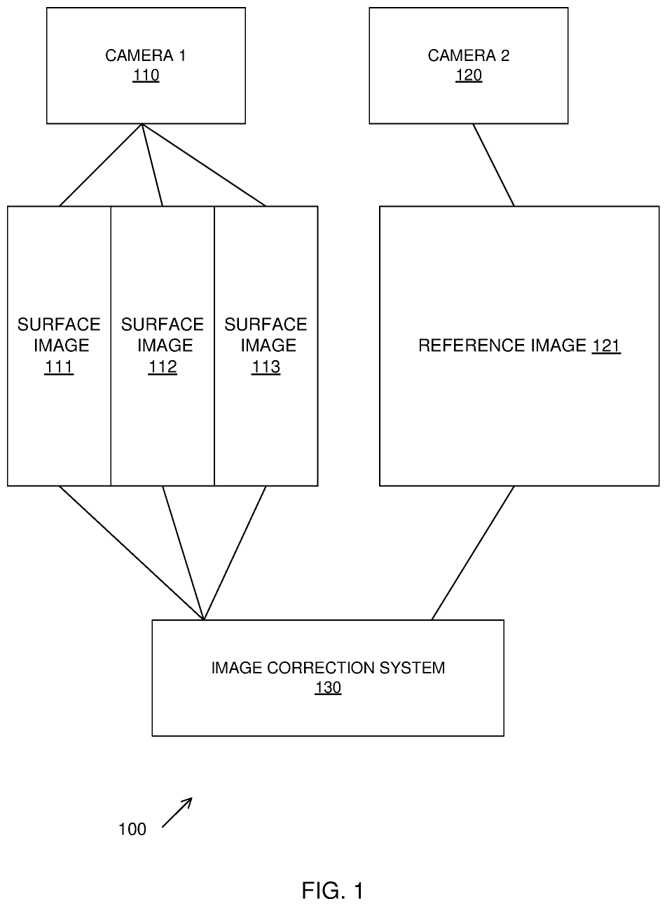

Referring to FIG. 1, a schematic diagram (100) illustrates an embodiment of the described method and system. A first camera (110) may capture and provide one or more surface images (111-113). A second camera (120) may capture and provide a reference image (121). In the described embodiment multiple surface images (111-113) may be mosaicked to provide a high resolution image covering an area. FIG. 1 shows a simplified arrangement of only three surface images (111-113), in reality there may be in the order of thousands of surface images covering an equivalent area of a reference image (121).

The multiple surface images (111-113) may be radiometrically corrected by an image correction system (130) by reference to the reference image (121). The reference image (121) may cover substantially the same area as the mosaicked multiple surface images (111-113) and may have been captured at substantially the same time. The reference image (121) has surface reflectance for each pixel of the reference image (121).

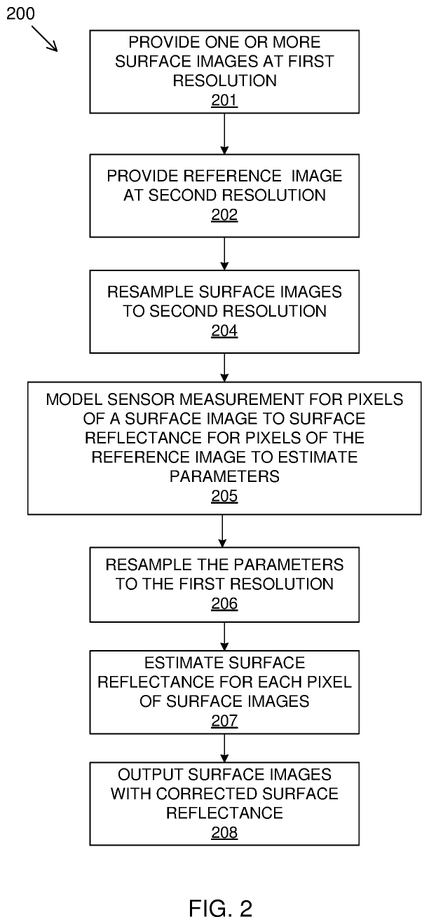

Referring to FIG. 2, a flow diagram (200) shows an example embodiment of the described method for generating radiometrically corrected surface images. FIG. 2 shows an overview of the method which is explained in more detail below.

The method may provide (201) one or more surface images of a first resolution of a surface area in the form of one or more digital images having a surface image sensor measurement (DN) of an intensity value of radiation in a given wavelength band reflected from the surface for each pixel of the images.

The method may also provide (202) a reference image of a second resolution of a corresponding surface area to the surface area of the multiple surface images. The reference image has surface reflectance (ρₜ) for each pixel of the reference image which may be corrected for atmospheric and BRDF effects for an equivalent wavelength band to the given wavelength band of the multiple surface images.

The method may include resampling (204) the multiple surface images to the second resolution. The method may model (205) a spatially varying local linear relationship that relates the surface image sensor measurement for pixels of a surface image to the surface reflectance (ρₜ) for pixels of the reference image to provide an estimated surface reflectance for each pixel of the surface images. The linear relationship describes the atmospheric and BRDF effects locally, i.e. in a small spatial region. As the BRDF and atmospheric effects vary spatially, so too do the parameters of the linear relationship.

The model may estimate parameters (M, C) in the form of spatially varying parameters of the linear relationship that relates the surface image sensor measurement for pixels of a surface image to the surface reflectance for pixels of the reference image. If appropriate, one of the parameters (C) may omitted from the model, enabling a single parameter to be estimated and used.

The method may resample (206) the parameters to the first resolution and estimate (207) the surface reflectance for each pixel of the given wavelength band of the surface images using the resampled parameters.

The method may output (208) the surface images with corrected surface reflectance for each pixel at each wavelength band.

Formulation Combined BRDF, atmospheric and sensor corrections can be modelled as a spatially varying linear relationship between surface reflectance and sensor measurement. Following the notation of Lopez et al. (2011), the aerial sensor measurement for each band can be expressed as:

DN=c₀Lₛ+c₁ (Equation 1)

where DN is the sensor measurement, Lₛ is the radiance at the sensor and c₀ and c₁ are coefficients determined by the characteristics of the sensor. The radiance at the sensor is expressed as:

$${L}_{s} = \frac{{ρ}_{s} {E}_{s} cos θ}{π} \qquad ( Equation 2 )$$

where ρₛ is the reflectance at the sensor, Eₛ is the top of atmosphere (TOA) irradiance and θ is the solar zenith angle. The reflectance at the sensor is described by the radiative transfer equation (Vermote et al., 1997):

$${ρ}_{s} = {ρ}_{a} + \frac{{ρ}_{t}}{1 - S {ρ}_{t}} {τ}_{↑} {τ}_{↓} {τ}_{g} \qquad ( Equation 3 )$$

where ρₐ is the atmospheric reflectance, ρₜ is the surface reflectance and S is the atmospheric albedo. τ_{↑} and τ_{↓} are the atmospheric transmittances due to molecular and aerosol scattering between the surface and sensor and between the sun and the surface respectively and τ_{g} is the global atmospheric transmittance due to molecular absorption. The atmospheric albedo, S, is typically around 0.07 (Manabe and Strickler, 1964). With a small value for S, the denominator in Equation 3 is approximately one and the reflectance at the sensor can be approximated as:

ρₛ≅ρₐ+ρₜτ_{↑}τ_{↓}τ_{g} (Equation 4)

Equations 1, 2 and 4 express the relationship between the sensor measurement, atmospheric conditions and the surface reflectance. Note that the surface reflectance is subject to BRDF effects and so also varies with the viewing geometry. With the approximation of Equation 4, there is a linear relationship between surface reflectance and the sensor measurement. The parameters of this relationship are dependent on the atmospheric conditions and viewing geometry, and vary spatially and temporally. This linear relationship can be expressed as:

$$\begin{matrix}DN = M {ρ}_{t} + C \\ where & ( Equation 5 ) \\ M = \frac{1}{π} {c}_{0} {τ}_{↑} {τ}_{↓} {τ}_{g} {E}_{s} cos θ \\ and & ( Equation 6 ) \\ C = {c}_{1} + \frac{1}{π} {c}_{0} {ρ}_{a} {E}_{s} cos θ & ( Equation 7 )\end{matrix}$$

The parameters M and C, are spatially varying functions of the viewing geometry and atmospheric conditions. Use of a local linear relation to model radiative transfer is also advocated in Collings et al. (2011) and Gehrke (2010). Implicit in any radiometric calibration technique is an approximation of these parameters so that the relationship can be inverted.

In the proposed method, we solve for M and C of the aerial sensor using a reference estimate for the surface reflectance parameter, ρₜ, obtained from a well calibrated satellite image. The reference surface reflectance image should have been captured at a similar time to the uncalibrated aerial image(s) to avoid phenological or structural differences between the reference and uncalibrated images. The reference image will typically be at a substantially lower spatial resolution than the aerial imagery. Calibrated surface reflectance products, such as those produced from MODIS and MISR, have resolutions of the order of 500 m while aerial images usually have resolutions of 2 m or higher. This large resolution discrepancy is not ideal, but it is assumed that atmospheric and BRDF effects vary little at a small spatial scale and that the reference resolution is sufficient to capture gradual variations in atmospheric conditions and BRDF.

Least squares estimates of M and C, for the aerial sensor, are found for each pixel of the reference image inside a sliding window, as described by Equation 8. A sliding window is a small rectangular sub-region of the images. The least squares estimator is used to find M and C for the center pixel of the sliding window. The sliding window is shifted to each pixel location in the reference image, and the least squares estimation repeated using Equation 8.

$$[ \begin{matrix}M \\ C\end{matrix} ] = {[ \begin{matrix}{ρ}_{t} & 1\end{matrix} ]}^{- 1} DN \qquad ( Equation 8 )$$

where ρₜ and DN are row vectors of the N values inside the sliding window and 1 is a row vector of ones of length N. ρₜ is obtained from the reference image and DN from the aerial image(s). The sliding window should consist of at least two pixels to solve for the two parameters. In circumstances where the camera offset, c₁, is zero and atmospheric reflectance, ρₐ, is small, C may be regarded as being sufficiently small to be omitted from the model, in which case a sliding window of one pixel may be used. In order to accommodate the differing spatial resolutions, M and C must be found at the reference spatial resolution, resampled to the aerial spatial resolution, and then used to estimate surface reflectance at this resolution by inverting the relationship of Equation 5.

The procedure follows these steps:
1. Resample uncalibrated aerial images to the reference image resolution and grid.
2. Calculate estimates of M and C for each pixel of each band of the reference image using Equation 8. This forms two multi-band rasters M and C.
3. Resample M and C rasters to the aerial image resolution and grid.
4. Calculate estimated surface reflectance for each pixel of each band of the uncalibrated aerial image, using Equation 5.

In one embodiment, the uncalibrated aerial images are of a higher resolution than the reference image. Therefore, step 1, downsamples the uncalibrated aerial images and step 3 upsamples the M and C rasters.

It is noted that the proposed method assumes the spectral responses of the reference and uncalibrated sensors are identical. In practice, this does not hold true. The relation between surface reflectance and sensor measurement in Equation 5 becomes non-linear when including the spectral response effect. The surface reflectance in 5 is a band-averaged quantity as represented by Equation 9.

$${ρ}_{t} = \frac{\int {ρ}_{t} ( λ ) R ( λ ) d λ}{\int R ( λ ) d λ} \qquad ( Equation 9 )$$

where ρₜ(λ) is the spectral surface reflectance and R(λ) is the sensor relative spectral response (RSR) for a particular band. Without knowledge of the surface reflectance spectra, it is not possible to completely calibrate for this effect. However, for real world surface reflectances it can be shown that the relationship between the band averaged values for different sensors is approximately linear (Gao et al., 2013; Jiang and Li, 2009). This means the relationship between surface reflectance and sensor measurement remains approximately linear even when the sensor spectral response is considered. Although the calibration method proposed in this paper does not explicitly compensate for sensor spectral responses, it is assumed that the effect is locally linear and will consequently be incorporated into the model of Equation 5. This assumption is supported with simulations for the case study sensors in described below.

The choice of resampling algorithms in steps 1 and 3 of the procedure are important, especially when there is a large difference in the spatial resolution of the aerial and reference images. Optical imaging systems are linear and thus subject to the superposition principle which manifests as spectral mixing (refs). Averaging the uncalibrated image over each reference pixel area is recommended when downsampling in step 1. This will approximate the spectral mixing that occurs in the larger reference image pixels, although it does not account for the sensors' differing point spread functions (PSFs). In our approach it is assumed that the effect of differing PSFs is negligible.

Standard interpolation algorithms were tested for efficacy when upsampling in step 3. It is necessary to produce smooth M and C rasters in this step to satisfy the assumption of slowly varying atmospheric and BRDF effects and to avoid discontinuities in the final image(s). Cubic spline interpolation, with its constraints of continuity of the first and second derivatives, was found to best satisfy this requirement. The Geospatial Data Abstraction Library (GDAL) (GDAL Development Team, 2014) was used for implementing the resampling.

Blocks of aerial surface reflectance images generated with the procedure outlined above can be mosaicked without the need for additional colour balancing or normalisation procedures to reduce seam lines. Because a single reference satellite image will typically cover many aerial images, the calibrated images tend to combine into a seamless mosaic. Consideration must however be given to treatment of boundary pixels in steps 1 and 3 to minimise the formation of seam lines in the mosaic. For instance, when downsampling to the reference resolution in step 1, boundary pixels in the downsampled image that are only partially covered by aerial resolution pixels should be discarded as they can skew the estimates of M and C, especially for heterogeneous land covers. The condition of complete coverage can be relaxed somewhat to reduce discarded pixels. A condition of at least 90 percent coverage was used for our case study. When upsampling to the aerial resolution in step 3, the GDAL spline interpolator extrapolates pixels that lie outside the polygon formed by the centres of the reference resolution boundary pixels. This can cause discontinuities between adjacent images where extrapolation is inaccurate. Boundary conditions can be imposed on the spline interpolation to guarantee continuity between adjacent images, but if there is sufficient overlap between adjacent images, a simpler option is to discard the extrapolated boundary pixels before forming the mosaic. This is the approach that was adopted for the case study.

### Study Site, Data Collection and Preparation

The surface reflectance retrieval method proposed in this paper was tested in a 96 km×107 km area in the Little Karoo in South Africa. Very high resolution (VHR) 0.5 m/pixel multi-spectral aerial imagery was acquired from the Chief Directorate: National Geo-spatial Information (NGI), a component of the South African Department of Rural Development and Land Reform. The imagery was captured with a multispectral Intergraph DMC camera with red, green, blue and near-infrared (NIR) channels.

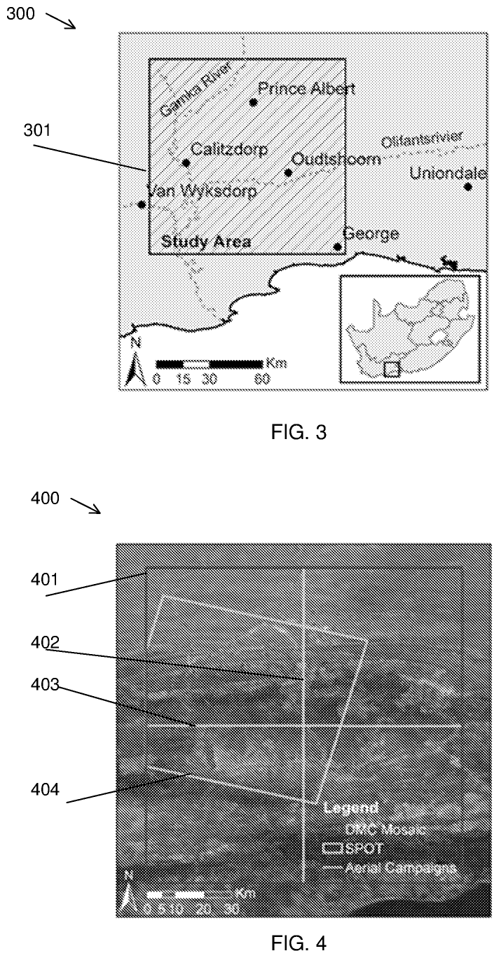

FIG. 3 shows a study area orientation map (300) with a study area (301).

The study site is covered by 2228 images captured during four separate aerial campaigns flown over multiple days from 22 Jan. 2010 to 8 Feb. 2010. The site was selected as the calibration work forms part of a larger vegetation mapping study being done in the area. The rectified imagery currently available from NGI has LUT and dodging adjustments made to it and is not suited to quantitative remote sensing. Thus, the raw imagery was obtained and corrected for lens distortion, band spatial alignment, sensor non-linearity and dark current using the Intergraph Z/I Post-Processing Software (PPS). The PPS corrected imagery was orthorectified using existing aero-triangulation data supplied by NGI.

A MODIS MCD43A4 composite image for the period from 25 Jan. 2010 to 9 Feb. 2010 was selected as a reference for the cross calibration. This image has a 500 m resolution and contains nadir BRDF-adjusted reflectance (NBAR) data composited from the best values over a 16 day period. The MODIS NBAR data has been processed with atmospheric and BRDF correction procedures (Strahler et al., 1999) and is recognised as a reliable reference source for cross calibration (Gao et al., 2013; Jiang and Li, 2009; Li et al., 2012; Liu et al., 2004). The NBAR data accuracy has been verified in a number of studies (MODIS Land Team, 2014). It was also selected as it has similar spectral bands to the Intergraph DMC. Bands 4, 1, 3 and 2 from the MODIS sensor were used to correspond to the red, green, blue and NIR bands from the DMC sensor respectively. The PPS processed imagery has zero offset, so the parameter c₁ from Equation 7 was zero and the atmospheric reflectance, ρₐ, was small as the surveys were flown on clear days. Thus, C was assumed to be small enough to be ignored and only the gain, M, was estimated. With only one parameter to estimate, a sliding window of one pixel was used to achieve the best possible spatial resolution in the M raster.

### Accuracy Assessment

Given that the imagery was acquired in 2010, it was not possibly to assess the accuracy of the reflectance retrieval method using ground-based spectral measures. Alternative methods for evaluating the results were consequently used. Firstly, the DMC DN and calibrated surface reflectance images were stitched into mosaics and the mosaics were visually compared to determine if discontinuities between adjacent images were reduced and to what extent the radiometric variations were corrected. Secondly, the DMC surface reflectance mosaic was resampled to the MODIS grid and resolution and statistically compared to the MODIS reference image.

Lastly, we quantitatively compared the DMC surface reflectance mosaic to a SPOT 5 scene. The 10 m resolution SPOT 5 level 1A image, acquired on 21 Jan. 2010, covers portions of all four aerial campaigns as shown in FIG. 4. FIG. 4 shows a surface image (400) with a first area (401) covered by DMC mosaic images with aerial campaign lines (402, 403) shown, and a second area (404) covered by a SPOT 5 scene. The image was ortho-rectified using a 5 m resolution digital elevation model (Van Niekerk 2014). The SPOT 5 DN image was converted to surface reflectance using the Atmospheric/Topographic CORrection (ATCOR-3) method (Richter, 1997). Since the SPOT 5 sensor does not have a blue band, it was omitted from this validation. The resulting surface reflectance image was statistically compared to the DMC surface reflectance mosaic and a difference image generated using Equation 10.

E(x,y)=|I^{DMC}(x,y)−I^{SPOT}(x,y)| (Equation 10)

where I^{DMC} is the DMC mosaic, I^{SPOT} is the SPOT 5 image, (x,y) are the pixel co-ordinates and E is the difference image. The difference image was used to identify spatial patterns in the discrepancies between the corrected SPOT 5 image and DMC mosaic. The SPOT 5 resolution of 10 m allows the surface reflectance result to be checked at a resolution significantly closer to the aerial resolution than the reference MODIS resolution. This provides a useful check of the assumption that BRDF and atmospheric variations occur gradually and can thus be approximated at the coarse scale of the reference image. While the MODIS comparison is checking the DMC surface reflectance against the reference it was fitted to, the SPOT 5 comparison is using an independent and “unseen” source.

### Results and Discussion

### Band Averaged Relationships

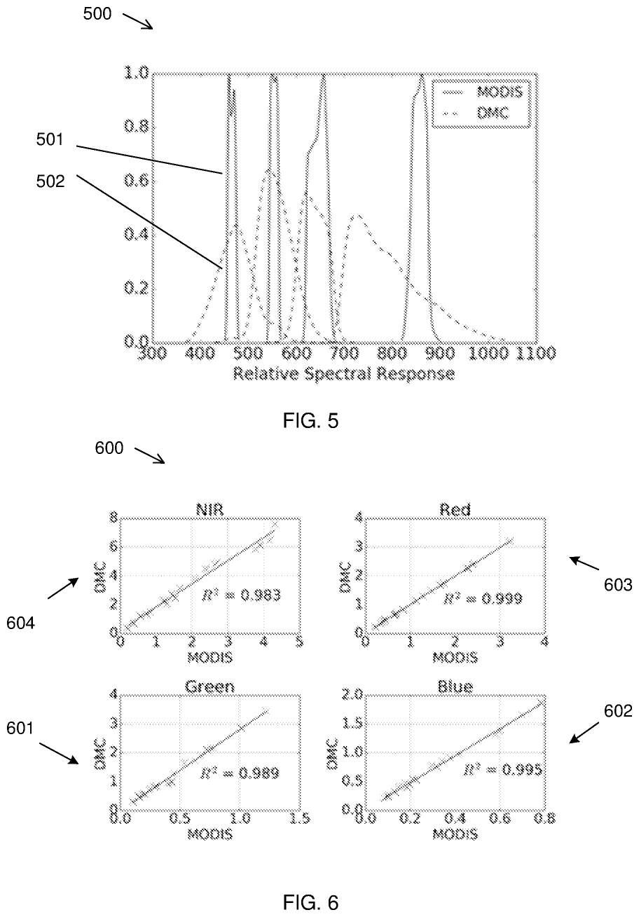

The relative spectral responses (RSR's) of the DMC and MODIS sensors are shown in a graph (500) of FIG. 5. The solid line (501) shows the relative spectral response of the MODIS sensor and the dashed line (502) shows the relative spectral response of the DMC sensor. While the assumption of identical RSR between the two sensors is obviously not satisfied, the peak overlap between the sensors is good in all bands with the exception of NIR.

Band averaged values were simulated using typical surface reflectance spectra obtained from the ASTER spectral library (Baldridge et al., 2009). Twenty spectra were selected from the “soil”, “vegetation”, “water” and “man-made” classes to represent commonly encountered land covers. These were used with the sensor RSR's in Equation 9 to simulate the band averaged values for each sensor. The measured band-averaged reflectance relationship between the two sensors is shown in the graphs (600) of FIG. 6 with DMC vs MODIS band averaged relationship for typical surface reflectances with R² values shown for each wavelength band green (601), blue (602), red (603), and NIR (604). The correlation between the DMC and MODIS band-averaged values (shown in FIG. 6) is surprisingly strong considering the disparity between the RSR's (shown in FIG. 5). This is attributed to the consistency of most real-world reflectance spectra within any individual band (refs). This result supports the incorporation of the band averaging effect into the linear reflectance model of Equation 5. As the proposed method only requires the relationship to be locally linear, the variety of land covers simulated here is unlikely to be present inside the sliding window used to estimate the model parameters. For a small sliding window the correlation of the band averaged values will consequently be even stronger than what is shown in FIG. 6.

### Mosaicking

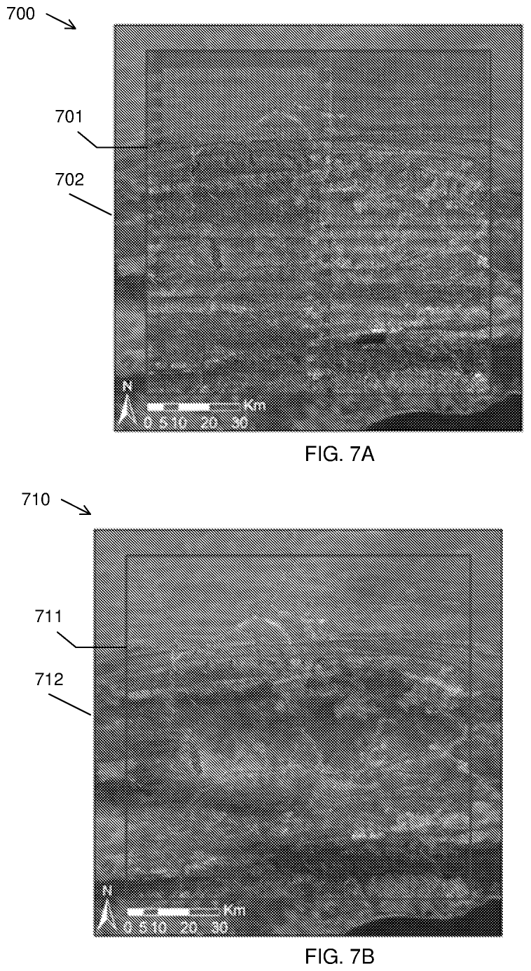

FIG. 7A shows an image (700) of a camera calibrated mosaic on a MODIS reference image background without radiometric correction. A RGB mosaic of DMC DN images (bordered as reference (701)) is shown against a background (702) of the MODIS reference image. Seam lines between adjacent DMC images and radiometric variations over the set of images are clearly visible.

Each DMC image was converted to surface reflectance using the proposed method. A RGB mosaic of the corrected images is shown in the image (710) of FIG. 7B, bordered with reference (711), against a background of the MODIS reference image (712). No seam lines or radiometric issues (e.g. hot spots) are apparent at this scale, and the corrected images match the reflectance of the MODIS reference image.

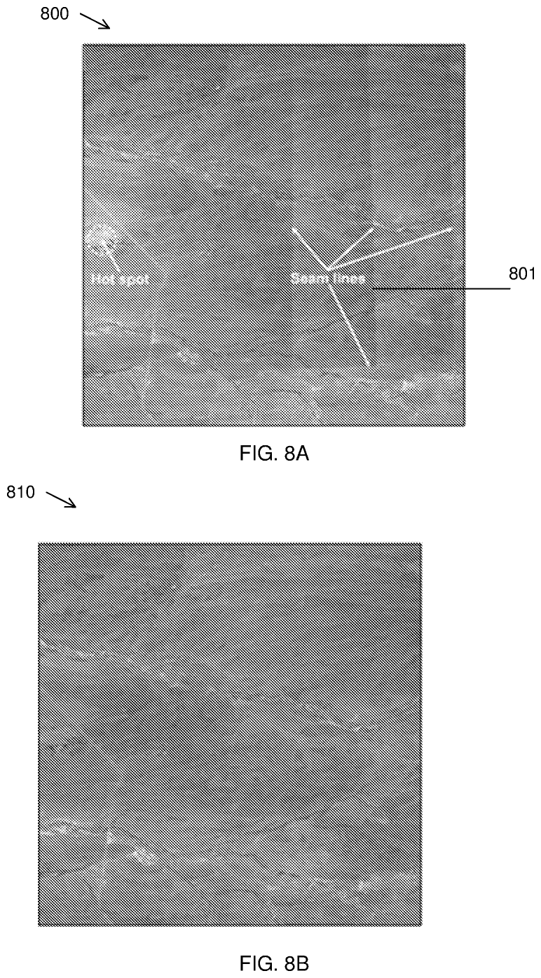

FIG. 8A shows a close-up section (800) of the DMC DN mosaic where a hot spot (i.e. a BRDF effect where sunlight is strongly reflected back into the camera) and seam lines (801) between adjacent images are visible. FIG. 8B demonstrates the same section (810) with the successful removal of the hot spot and seam lines after correction with the surface reflectance extraction method.

### MODIS Comparison

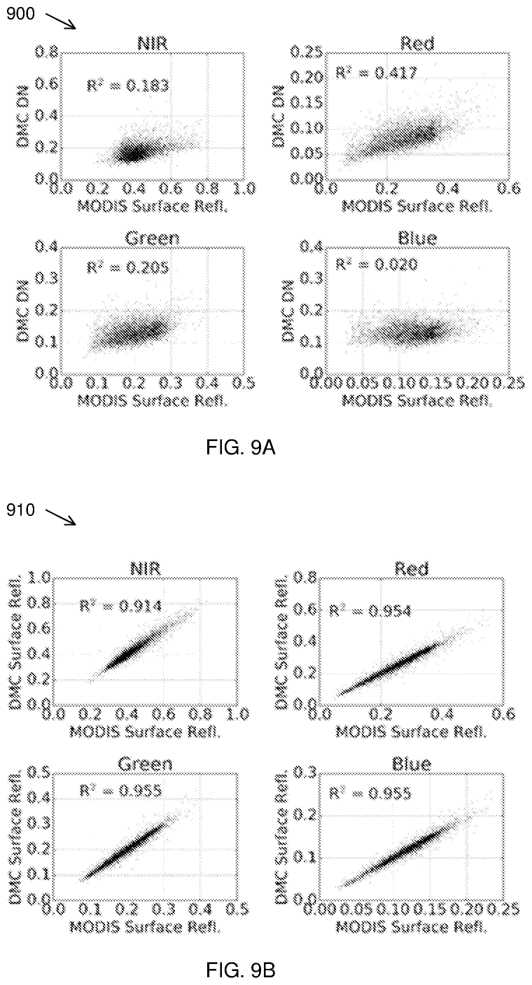

FIG. 9A shows scatter plots (900) of the DMC DN and MODIS surface reflectance values with R² coefficients indicating correlation strength. FIG. 9B shows similar scatter plots (910) for the DMC and MODIS surface reflectance values. Differences in the MODIS and DMC surface reflectance values at MODIS resolution are due in part to the use of the cubic spline interpolation to upsample the M and C rasters from the MODIS to DMC resolution. The spline interpolation is non-invertible (i.e. downsampling the upsampled rasters does not produce the original M and C rasters but successively smoothes the data at each application). As indicated by FIG. 9A and FIG. 9B, the correlation of the DMC and MODIS values is significantly improved when using the extracted DMC surface reflectance rather than DN values. This improvement in correlation is not unexpected, as FIG. 9B is effectively comparing calibrated values to the values that were used for calibration. Nevertheless, this comparison serves as a general check on the validity of the method and as an indication of the effect of spline interpolation between the disparate MODIS and DMC resolutions. Mean absolute difference (MAD), root mean square (RMS), standard deviation and coefficient of determination statistics are given for the DMC and MODIS surface reflectance values in Table 1. Reflectance differences are greatest in the NIR band most likely due to the dissimilar MODIS and DMC RSRs in this band (FIG. 5). This demonstrates the importance of using a reference image from a sensor with similar RSRs to those of the target imagery.

TABLE 1
Statistical comparison between MODIS
and DMC surface reflectance images

| | Mean Abs. | Root Mean | Std. Dev. | |
|---|---|---|---|---|
| Band(s) | Diff. (%) | Square (%) | Diff. (%) | R² |
| Near infrared | 1.70 | 2.50 | 2.50 | 0.91 |
| Red | 1.18 | 1.75 | 1.75 | 0.95 |
| Green | 0.79 | 1.16 | 1.16 | 0.96 |
| Blue | 0.48 | 0.69 | 0.69 | 0.96 |
| All | 1.04 | 1.67 | 1.67 | |

### SPOT 5 Comparison

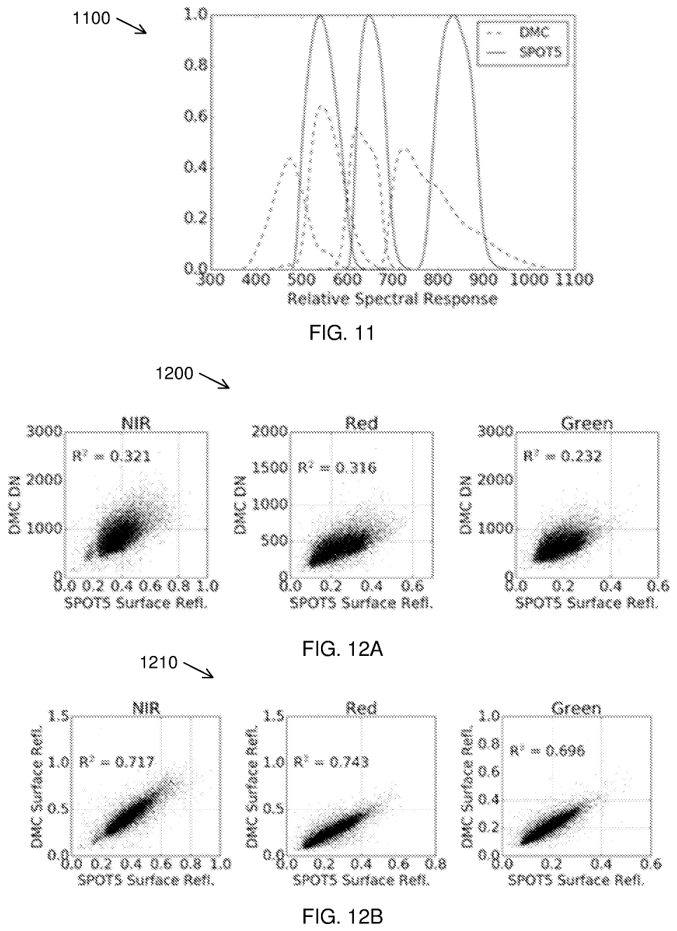

Statistics for the reflectance difference between the corrected SPOT 5 image and the DMC surface reflectance mosaic are shown in Table 2. Not all of the reflectance differences can be attributed to errors in the calibrated DMC surface reflectances. Spatial misalignment of pixels due to ortho-rectification differences and errors in the SPOT 5 surface reflectance also contribute to the recorded differences. The relatively low mean overall absolute reflectance difference of 4.18% is consequently a good indication that the surface reflectance extraction method is effective. These reflectance differences compare well to figures reported by other aerial image correction methods. Collings et al. (2011) achieved RMS reflectance errors of 4-10% measured on placed targets of known reflectance for their aerial mosaic correction technique, and in the aero-triangulation approach of Lopez et al. (2011), mean absolute reflectance differences of 3-5% were obtained on field measured test sites, distributed throughout their study area. Similarly to the MODIS comparison, the largest reflectance differences occur in the NIR band. Again, this is likely due to dissimilarities in the MODIS, DMC and SPOT 5 sensor NIR RSR's (FIG. 5 and FIG. 11 which shows a graph (1100) of DMC and SPOT 5 RSRs).

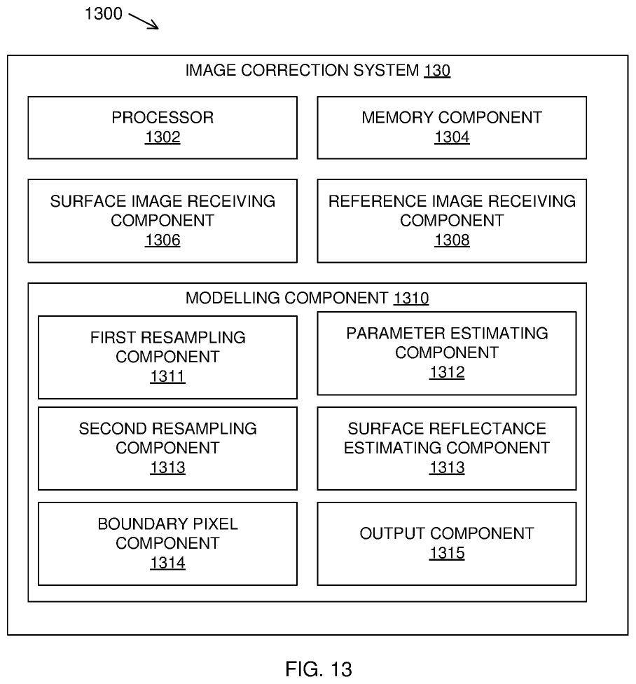

Scatter plots (1200) of DMC DN and SPOT 5 surface reflectance values are shown in FIG. 12A and scatter plots (1210) DMC surface reflectance and SPOT 5 surface reflectance values are shown in FIG. 12B with R² coefficients indicating correlation strength. The conversion to DMC surface reflectance provides a substantial improvement in correlation between the DMC and SPOT 5 values.

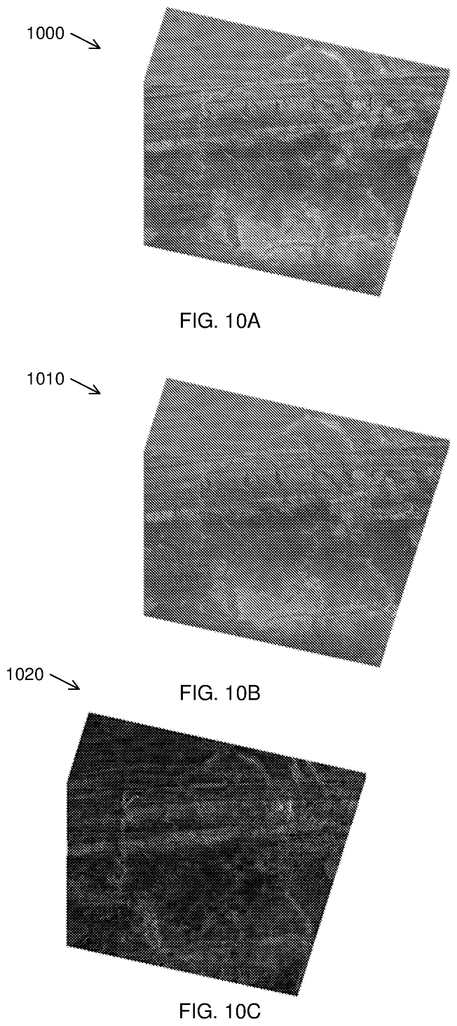

False colour CIR (colour-infrared) renderings of the DMC, SPOT 5 and difference images are shown in the images (1000, 1010, 1020) of FIGS. 10A, 10B and 10C. The contrast stretched difference image shows that most discrepancies occur in the rugged mountainous areas that extend west to east in the northern section of the scene and in densely vegetated areas along river banks in the southern section of the scene. Disparities in the mountainous areas are mainly due to differing shadow effects which are likely caused by variations in the time of day when the images were captured (the aerial photographs were captured throughout the day, while the SPOT 5 image was captured at 8:29 am). A particularly bright area is noticeable in the upper right corner of the difference image. This corresponds to an area of bare ground which is bright in both the DMC and MODIS images and likely corresponds to a BRDF correction failure. It is not possible to say if this failure is in the SPOT 5 and or DMC corrections. The differences in the densely vegetated areas are attributed to the differences in the MODIS, DMC and SPOT 5 sensor NIR RSR's being amplified by the known high NIR reflectivity of vegetation.

TABLE 2
Statistical comparison between SPOT
5 and DMC surface reflectance images

| | Mean Abs. | Root Mean | Std. Dev. | |
|---|---|---|---|---|
| Band(s) | Diff. (%) | Square (%) | Diff. (%) | R² |
| Near infrared | 5.88 | 7.72 | 6.18 | 0.717 |
| Red | 3.74 | 5.42 | 4.84 | 0.743 |
| Green | 2.93 | 4.29 | 3.65 | 0.696 |
| All | 4.18 | 5.99 | 5.11 | |

### CONCLUSIONS

This study proposes a method of estimating surface reflectance from aerial imagery by calibrating to a course-resolution, concurrent and collocated image that has already been corrected for atmospheric and BRDF effects. The model parameters are estimated, for each satellite pixel location, using least squares inside a small sliding window. The proposed surface reflectance extraction method was applied to 2228 Intergraph DMC images covering an area 96×107 km in size. A MODIS MCD43A4 image was used as the surface reflectance reference. The extracted DMC surface reflectance mosaic was free of visible seam lines and hot spots and matched the MODIS reference well. The DMC surface reflectance mosaic was also compared to a concurrent SPOT 5 image in order to establish the method efficacy at a spatial resolution closer to that of the DMC source resolution than the MODIS reference. The SPOT 5 image was corrected for atmospheric effects and converted to surface reflectance using the ATCOR-3 method. The mean absolute reflectance difference between the DMC mosaic and SPOT 5 image was 4.18%. This reflectance difference is considered supportive of the method's accuracy and is similar to figures reported by Collings et al. (2011) and López et al. (2011) for more complex correction techniques.

The proposed technique is simpler and computationally more efficient than existing aerial image correction approaches as it avoids the need for explicit BRDF and atmospheric correction as well as mosaic normalisation techniques to reduce seam lines. The spatially varying linear model allows for great flexibility in the BRDF characteristics that can be corrected for. It does however assume that BRDF and atmospheric variations are gradual and can be captured by the coarser resolution of the reference image. Real BRDF can vary significantly over short distances where land cover is heterogeneous. We regard the assumption of slowly varying BRDF as a necessary limitation of the method, and it is one that is shared by others (Chandelier and Martinoty, 2009; Collings et al., 2011; Gehrke, 2010; López et al., 2011). The extracted surface reflectance can also only be as accurate as the reference of course. According to the MODIS land team (2014), the NBAR data used in the case study is accurate to “well less than 5% albedo at the majority of the validation sites”. The method is also limited by the need for a reference image concurrent and spectrally similar to the aerial imagery. Such an image may not always be obtainable.

The MODIS and DMC RSR's are quite different, particularly in the near infrared region of the spectrum FIG. 5. The surface reflectance extraction method assumes the effect of different sensor spectral responses is linear and will be contained by the model of Equation 8. This assumption was confirmed by a simulation of MODIS and DMC measurements for typical land cover spectra. The relatively higher (5.88%) NIR reflectance difference between the DMC mosaic and the SPOT 5 values, and discrepancies in vegetated areas, are likely due to the more exaggerated differences in NIR RSR's between the MODIS, DMC and SPOT sensors.

While the results of the surface reflectance extraction technique were surprisingly good given the simplicity of the method, many aspects warrant further investigation. Evaluation of the efficacy of using different sensors to provide the reflectance reference is of interest. Local terrain effects are poorly represented at the MODIS resolution. It would be informative to test the method with a higher spatial resolution reference such as Landsat Operational Land Imager (OLI). The MISR instrument is also a promising alternative to MODIS and could also be evaluated as a reflectance reference. MISR RSR's are a better match to those of the Intergraph DMC than the MODIS bands, and it is possible to obtain 275 m reflectance products using MISR-HR (Verstraete et al., 2012). Strong emphasis is placed on accurate calibration of the MISR data as its instrument captures data at nine different angles which allows a more accurate modelling of the BRDF compared to the kernel based approach followed in the calibration of the MODIS data (Strahler et al., 1999).

In our case study, we assumed the parameter C in the model of Equation 5 was small enough to be ignored. Some haze was however visible in the blue band, casting doubt on this assumption. It would be interesting to investigate the effect of including C in the model. The effect of the size of the sliding window used to estimate M and C on accuracy was not investigated and should also be evaluated. One would expect a larger sliding window to reduce variance by averaging out local noise but decrease effective spatial resolution by smoothing the M and C rasters.

The technique was applied to a set of 2228 overlapping aerial images captured with an Intergraph DMC camera. A near-concurrent MODIS MCD43A4 image was used as the reflectance reference dataset. The resulting DMC mosaic was compared to a near-concurrent SPOT 5 reflectance image of the same area, and the mean absolute reflectance difference was found to be 4.18%, which compares well to the accuracy of other aerial image correction methods.

This approach avoids the need to perform time consuming and complex atmospheric and BRDF corrections explicitly. It also avoids the need for placement of known reflectance targets or field spectral measurements which can be impractical and time-consuming in many instances. This procedure borrows conceptually from the field of cross calibration (Liu et al., 2004; Teillet et al., 2001), where one uncalibrated satellite sensor is calibrated to another well-calibrated satellite sensor using concurrent images of an area of known surface reflectance. It can also be considered a form of data fusion (Pohl and Van Genderen, 1998) in that it is fusing high resolution raw “digital number” (DN) data with and coarse resolution surface reflectance data to obtain high resolution surface reflectance data. Results obtained are compelling and indicate that the accuracy of the method is comparable to or possibly better than more complex approaches.

### Exemplary Embodiment of the System

Referring to FIG. 13, a system diagram (1300) shows an example embodiment of the image correction system (130).

The image correction system (130) may include a processor (1302) for executing the functions of components described below, which may be provided by hardware or by software units executing on the image correction system (130). The software units may be stored in a memory component (1304) and instructions may be provided to the processor (1302) to carry out the functionality of the described components.

The image correction system (130) may include a surface image receiving component (1306) for receiving one or more surface images of a first resolution of a surface area in the form of one or more digital images having a surface image sensor measurement (DN) of an intensity value of radiation in a given wavelength band reflected from the surface for each pixel of the images. The surface image receiving component (1306) may receive surface images from a surface image sensor which may be indirectly via an imagery supplier.

The image correction system (130) may include a reference image receiving component (1308) for providing a reference image of a second resolution of a corresponding surface area to the surface area of the multiple surface images. The reference image has surface reflectance (ρₜ) for each pixel of the reference image for an equivalent wavelength band to the given wavelength band of the multiple surface images and may be obtained by a reference image sensor.

The image correction system (130) may include a modelling component (1310) for modelling a spatially varying linear relationship that relates the surface image sensor measurement for pixels of a surface image to the surface reflectance (ρₜ) for pixels of the reference image to provide an estimated surface reflectance for each pixel of the surface images. The modelling component (1310) may use a spatially varying local linear model to approximate a relationship between the surface reflectance of the reference image and the surface image sensor measurements of the surface images.

The modelling component (1310) may include: a first resampling component (1311) for resampling the multiple surface images to the second resolution; a parameter estimating component (1312) for estimating parameters (M, C) in the form of a spatially varying parameters of the linear relationship that relates the surface image sensor measurement for pixels of a surface image to the surface reflectance for pixels of the reference image; a second resampling component (1313) for resampling parameters to the first resolution; and a surface reflectance estimating component (1314) for estimating the surface reflectance for each pixel of the given wavelength band of the surface images using the resampled parameters.

The modelling component (1310) may include a boundary pixel component (1314) for treating bounding pixels of the surface images by discarding only partially included pixels. The modelling component (1310) may also include an output component (1315) for outputting the estimated surface reflectance of the surface images for use in remote sensing and other applications.

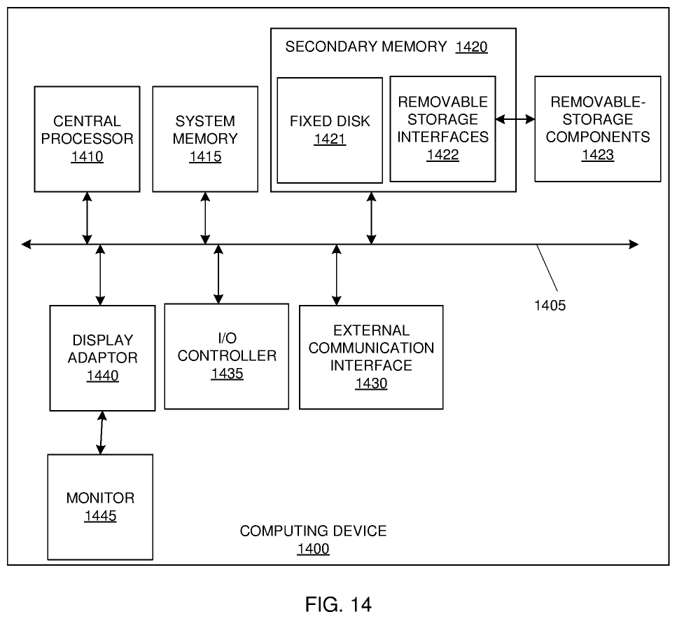

FIG. 14 illustrates an example of a computing device (1400) in which various aspects of the disclosure may be implemented. The computing device (1400) may be suitable for storing and executing computer program code. The various elements in the previously described system diagrams, may use any suitable number of subsystems or components of the computing device (1400) to facilitate the functions described herein. The computing device (1400) may include subsystems or components interconnected via a communication infrastructure (1405) (for example, a communications bus, a cross-over bar device, or a network). The computing device (1400) may include one or more central processors (1410) and at least one memory component in the form of computer-readable media. In some configurations, a number of processors may be provided and may be arranged to carry out calculations simultaneously. In some implementations, a number of computing devices (1400) may be provided in a distributed, cluster or cloud-based computing configuration and may provide software units arranged to manage and/or process data on behalf of remote devices.

The memory components may include system memory (1415), which may include read only memory (ROM) and random access memory (RAM). A basic input/output system (BIOS) may be stored in ROM. System software may be stored in the system memory (1415) including operating system software. The memory components may also include secondary memory (1420). The secondary memory (1420) may include a fixed disk (1421), such as a hard disk drive, and, optionally, one or more removable-storage interfaces (1422) for removable-storage components (1423). The removable-storage interfaces (1422) may be in the form of removable-storage drives (for example, magnetic tape drives, optical disk drives, etc.) for corresponding removable storage-components (for example, a magnetic tape, an optical disk, etc.), which may be written to and read by the removable-storage drive. The removable-storage interfaces (1422) may also be in the form of ports or sockets for interfacing with other forms of removable-storage components (1423) such as a flash memory drive, external hard drive, or removable memory chip, etc.

The computing device (1400) may include an external communications interface (1430) for operation of the computing device (1400) in a networked environment enabling transfer of data between multiple computing devices (1400). Data transferred via the external communications interface (1430) may be in the form of signals, which may be electronic, electromagnetic, optical, radio, or other types of signal. The external communications interface (1430) may enable communication of data between the computing device (1400) and other computing devices including servers and external storage facilities. Web services may be accessible by the computing device (1400) via the communications interface (1430). The external communications interface (1430) may also enable other forms of communication to and from the computing device (1400) including, voice communication, near field communication, radio frequency communications, such as Bluetooth™, etc.

The computer-readable media in the form of the various memory components may provide storage of computer-executable instructions, data structures, program modules, software units and other data. A computer program product may be provided by a computer-readable medium having stored computer-readable program code executable by the central processor (1410). A computer program product may be provided by a non-transient computer-readable medium, or may be provided via a signal or other transient means via the communications interface (1430).

Interconnection via the communication infrastructure (1405) allows the central processor (1410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, and the like) may couple to the computing device (1400) either directly or via an I/O controller (1435). These components may be connected to the computing device (1400) by any number of means known in the art, such as a serial port. One or more monitors (1445) may be coupled via a display or video adapter (1440) to the computing device (1400).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method for generating radiometrically corrected surface images comprising:
providing one or more surface images of a first resolution of a surface area in the form of one or more digital images having a surface image sensor measurement (DN) of an intensity value of radiation in a given wavelength band reflected from the surface for each pixel of the images;
providing a reference image of a second resolution of a corresponding surface area to the surface area of the one or more surface images, wherein the reference image has surface reflectance (ρₜ) for each pixel of the reference image for an equivalent wavelength band to the given wavelength band of the one or more surface images; and
modelling a functional relationship that relates the surface image sensor measurement for pixels of a surface image to the surface reflectance (ρₜ) for pixels of the reference image to provide an estimated surface reflectance for each pixel of the surface images.

2. The method as claimed in claim 1, wherein modelling the functional relationship uses a spatially varying local linear model to approximate a relationship between the surface reflectance of the reference image and the surface image sensor measurements of the one or more surface images.

3. The method as claimed in claim 2, wherein the modelling uses a linear relationship in which a surface image sensor measurement (DN) is equal to a first parameter (M) multiplied by surface reflectance (ρₜ) for each pixel of the reference image, wherein the first parameter is a spatially varying parameter estimated from the pixel values of the surface and reference images.

4. The method as claimed in claim 3, wherein the modelling uses a linear relationship with a second parameter (C) to take the form DN=Mρₜ+C, wherein the first and second parameters are spatially varying parameters estimated from the pixel values of the surface and reference images.

5. The method as claimed in claim 4, including:
resampling the one or more surface images to the second resolution;
estimating the first and second parameters (M,C) of the local linear relationship that relates the surface image sensor measurement for pixels of a surface image to the surface reflectance for pixels of the reference image;
resampling the estimated parameters to the first resolution; and
estimating the surface reflectance for each pixel of the given wavelength band of the one or more surface images using the resampled parameters.

6. The method as claimed in claim 3, wherein estimating the first parameter uses a least squares estimate for each pixel of the reference image inside a sliding window.

7. The method as claimed in claim 4, wherein estimating the first and second parameters (M,C) uses a least squares estimate for at least two pixels of the reference image inside a sliding window using the equation
$$[ \begin{matrix}M \\ C\end{matrix} ] = {[ \begin{matrix}{ρ}_{t} & 1\end{matrix} ]}^{- 1} DN ,$$
where ρₜ and DN are row vectors of the ρₜ and DN values inside the sliding window, respectively.

8. The method as claimed in claim 3, wherein the first resolution is higher than the second resolution and the modelling downsamples the one or more surface images and upsamples the parameter.

9. The method as claimed in claim 1, wherein the method includes treating bounding pixels by discarding only partially included pixels.

10. (canceled)

11. The method as claimed in claim 1, wherein the one or more surface images of a first resolution are high resolution aerial images and the reference image is a low resolution satellite image, wherein the one or more surface images and the satellite image are obtained at approximately the same time.

12. (canceled)

13. (canceled)

14. A system for generating radiometrically corrected surface images, comprising:
a surface image receiving component for receiving one or more surface images of a first resolution of a surface area in the form of digital images having a surface image sensor measurement (DN) of an intensity value of radiation in a given wavelength band reflected from the surface for each pixel of the images;
a reference image receiving component for providing a reference image of a second resolution of a corresponding surface area to the surface area of the one or more surface images, wherein the reference image has surface reflectance (ρₜ) for each pixel of the reference image for an equivalent wavelength band to the given wavelength band of the one or more surface images; and
a modelling component for modelling a functional relationship that relates the surface image sensor measurement for pixels of a surface image to the surface reflectance (ρₜ) for pixels of the reference image to provide an estimated surface reflectance for each pixel of the surface images.

15. The system as claimed in claim 14, wherein the modelling component uses a spatially varying local linear model to approximate a relationship between the surface reflectance of the reference image and the surface image sensor measurements of the one or more surface images.

16. The system as claimed in claim 15, wherein the modelling component uses a linear relationship in which a surface image sensor measurement (DN) is equal to a first parameter (M) multiplied by surface reflectance (ρₜ) for each pixel of the reference image, wherein the first parameter is a spatially varying parameter estimated from the pixel values of the surface and reference images.

17. The system as claimed in claim 16, wherein the modelling component uses a linear relationship with a second parameter (C) to take the form DN=Mρₜ+C, wherein the first and second parameters are spatially varying parameters estimated from the pixel values of the surface and reference images.

18. The system as claimed in claim 17, including:
a first resampling component for resampling the one or more surface images to the second resolution;
a parameter estimating component for estimating the first and second-parameters (M, C) of the local linear relationship that relates the surface image sensor measurement for pixels of a surface image to the surface reflectance for pixels of the reference image;
a second resampling component for resampling the estimated parameters to the first resolution; and
a surface reflectance estimating component for estimating the surface reflectance for each pixel of the given wavelength band of the surface images using the resampled parameters.

19. The system as claimed in claim 16, wherein the parameter estimating component estimates the first parameter fusing a least squares estimate for each pixel of the reference image inside a sliding window.

20. The system as claimed in claim 17, wherein the parameter estimating component estimates the first and second parameters (M,C) in which case the sliding window uses at least two pixels using the equation
$$[ \begin{matrix}M \\ C\end{matrix} ] = {[ \begin{matrix}{ρ}_{t} & 1\end{matrix} ]}^{- 1} DN ,$$
where ρₜ and DN are row vectors of the ρₜ and DN values inside the sliding window, respectively.

21. The system as claimed in claim 18, wherein the first resolution is higher than the second resolution and the first resampling component downsamples the one or more surface images and the second resampling component upsamples at least one parameter.

22. The system as claimed in claim 14, wherein the modelling component includes a boundary pixel component for treating bounding pixels of the one or more surface images by discarding only partially included pixels.

23. (canceled)

24. A computer program product, the computer program product comprising a computer-readable medium having stored computer-readable program code for performing the steps of:
providing one or more surface images of a first resolution of a surface area in the form of digital images having a surface image sensor measurement (DN) of an intensity value of radiation in a given wavelength band reflected from the surface for each pixel of the images;
providing a reference image of a second resolution of a corresponding surface area to the surface area of the one or more surface images, wherein the reference image has surface reflectance (ρₜ) for each pixel of the reference image for an equivalent wavelength band to the given wavelength band of the one or more surface images; and
modelling a functional relationship that relates the surface image sensor measurement for pixels of a surface image to the surface reflectance (ρₜ) for pixels of the reference image to provide an estimated surface reflectance for each pixel of the surface images.
